(19) United States
(12) Patent Application Publication
(10) Pub. No.: US 2015/0333463 A1
(43) Pub. Date: Nov. 19, 2015

(54) CONNECTION STRUCTURE FOR ELECTRIC COMPONENTS

(71) Applicant: YAZAKI CORPORATION, Tokyo (JP)

(72) Inventor: Shinji MOCHIZUKI, Shizuoka (JP)

(21) Appl. No.: 14/807,952

(22) Filed: Jul. 24, 2015

Related U.S. Application Data
(63) Continuation of application No. PCT/JP2014/050332, filed on Jan. 10, 2014.

(30) Foreign Application Priority Data
Jan. 29, 2013 (JP) 2013-013842

(51) Int. Cl. H01R 25/16; H01R 13/66; H01R 13/717

(52) U.S. Cl. CPC H01R 25/162; H01R 13/7175; H01R 13/6641

(57) ABSTRACT

A connection structure for electric components includes a pair of bus bars disposed side by side horizontally. An electric component and an electric component are disposed side by side vertically between the bas bars, and electrically connected to the bas bars. The bus bars include outside walls formed as outside faces when the bas bars are disposed side by side, respectively. Each of the outside walls includes a connection point connected to an electrode of the electric component, and a wall portion for preventing displacement of the electric component.

### CROSS REFERENCE TO RELATED APPLICATIONS

This application is a continuation application of International Application No. PCT/JP2014/050332, filed on Jan. 10, 2014, which claims priority to Japanese Patent Application No. 2013-013842, filed on Jan. 29, 2013, the entire contents of which are incorporated by references herein.

### BACKGROUND

1. Technical Field

The present invention relates to a connection structure for electric components in which the electrical components are electrically connected to a pair of bus bars.

2. Description of the Related Art

Some of the connection structures for electric components in which electric components, such as LED (light emitting diode) and zener diode, are electrically connected with each other via a conductive member heretofore use a bus bar formed by press work such as bending or punching of a conductive plate-shaped member. Patent Literature 1 describes a connection structure for the electric components in which a pair of bus bars are disposed side by side, and a first electric component and a second electric component are connected to the pair of the bus bars in a state where the first electric component and the second electric component having a smaller width in a horizontal direction and a smaller space between electrodes than those of the first electric component are disposed side by side vertically between the pair of the bus bars.

The connection structure for the electric components described in Japanese Patent Laid-Open Publication No. 2012-124149 (Patent Literature 1) reduces the number of components of the bus bar by sharing the bus bars in a pair.

### SUMMARY OF THE INVENTION

As described with reference to FIG. 9, in a connection structure 700 for the electric components described in the Patent Literature 1, a pair of bus bars 710, 710 are aligned in a horizontal direction. Each bus bar 710 includes two pairs of contacts disposed in the horizontal direction. When the pair of bus bars 710, 710 are aligned in the horizontal direction, four contacts for one stage are aligned in the horizontal direction. Therefore, as illustrated in FIG. 9, when the electric components 720, 730, come into contact with not more than three contacts of the four contacts, either one of the pair of bus bars 710, 710, does not contribute to electrical contact with the electric components 720, 730 but may include a wall 710a that functions only as an outside face. In other words, when the pair of bus bars 710, 710 are used, depending on specification (dimension, location of contact) of the electric component to be connected to the pair of bus bars 710, 710, a width of an alignment direction of the bus bars 710, 710 can become unnecessarily large. Further, the bus bars 710, 710 in the Patent Literature 1 do not include walls surrounding right and left sides of the electric components 720, 730. Therefore, the electric components 720, 730 might be displaced in the horizontal direction.

The present invention aims to provide the connection structure for the electric components capable of being made compact and preventing displacement of the electric component.

An aspect of the present invention is a connection structure for electric components including a pair of conductive bus bars disposed side by side horizontally and configured to electrically connect to a first electric component and a second electric component in a state where the first electric component and the second electric component are disposed side by side vertically, wherein each of the bus bars includes an outside wall formed as an outside face when the pair of bus bars are disposed side by side, the second electric component having a smaller width in a horizontal direction and a smaller space of two electrodes thereof in the horizontal direction than those of the first electric component, a contact formed at the outside wall to be connected to an electrode of the first electric component, and a displacement-prevention wall portion formed at the outside wall to prevent the second electric component from displacing in the horizontal direction by facing a side face of the second electric component with the paired one of the bus bars.

The outside wall of each of the bus bars may be formed in such a manner that the electric component displacement-prevention wall portion becomes closer to the side face of the second electric component as much as possible within a range where the contact can be connected to the electrode of the first electric component.

The each bus bar may include a right side wall and a left side wall facing each other in the horizontal direction. The outside wall is one of the right-side wall and the left-side wall and may be positioned at an outer side when the pair of bus bars are disposed side by side. The other wall of the right-side wall and the left-side wall may be an inside wall positioned at an inner side when the pair of bus bars are disposed side by side. The inside wall may include a contact connected to an electrode of the second electric component.

The first electric component may be zener diode. The second electric component may be LED.

According to the present invention, a connection structure for electric components can be provided that is capable of being made compact and preventing displacement of the electric component.

### BRIEF DESCRIPTION OF THE DRAWINGS

FIG. 1 is an exploded perspective view illustrating a lighting device into which a connection structure for electric components according to an embodiment of the present invention is incorporated.

FIG. 2A illustrates the lighting device illustrated in FIG. 1 viewed from a lens side.

FIG. 2B is the lighting device illustrated in FIG. 1 viewed from a back face side illustrated in FIG. 2A.

FIG. 3 illustrates a connection structure for electric components stored in a housing illustrated in FIG. 1 viewed from a back face side of the lens.

FIG. 4 is a cross-sectional view taken along the line A-A illustrating the connection structure for the electric components stored in the housing illustrated in FIG. 3.

FIG. 5 is a perspective view illustrating the connection structure for the electric components illustrated in FIG. 1.

FIG. 6 is a circuit diagram illustrating a structure of a power supply circuit of LED structured by a lighting function portion illustrated in FIG. 1.

FIG. 7A illustrates an assembly procedure of the lighting device into which the connection structure for the electric components is incorporated.

FIG. 7B illustrates the assembly procedure of the lighting device into which the connection structure for the electric components is incorporated.

FIG. 7C illustrates the assembly procedure of the lighting device into which the connection structure for the electric components is incorporated.

FIG. 7D illustrates the assembly procedure of the lighting device into which the connection structure for the electric components is incorporated.

FIG. 7E illustrates the assembly procedure of the lighting device into which the connection structure for the electric components is incorporated.

FIG. 7F illustrates the assembly procedure of the lighting device into which the connection structure for the electric components is incorporated.

FIG. 7G illustrates the assembly procedure of the lighting device into which the connection structure for the electric components is incorporated.

FIG. 7H illustrates the assembly procedure of the lighting device into which the connection structure for the electric components is incorporated.

FIG. 7I illustrates the assembly procedure of the lighting device into which the connection structure for the electric components is incorporated.

FIG. 8A is a perspective view illustrating a modification example of the lighting device into which the connection structure for the electric components according to the embodiment of the present invention is incorporated.

FIG. 8B is a perspective view illustrating the lighting device illustrated in FIG. 8A.

FIG. 9 illustrates problems of the prior art.

### DESCRIPTION OF THE EMBODIMENTS

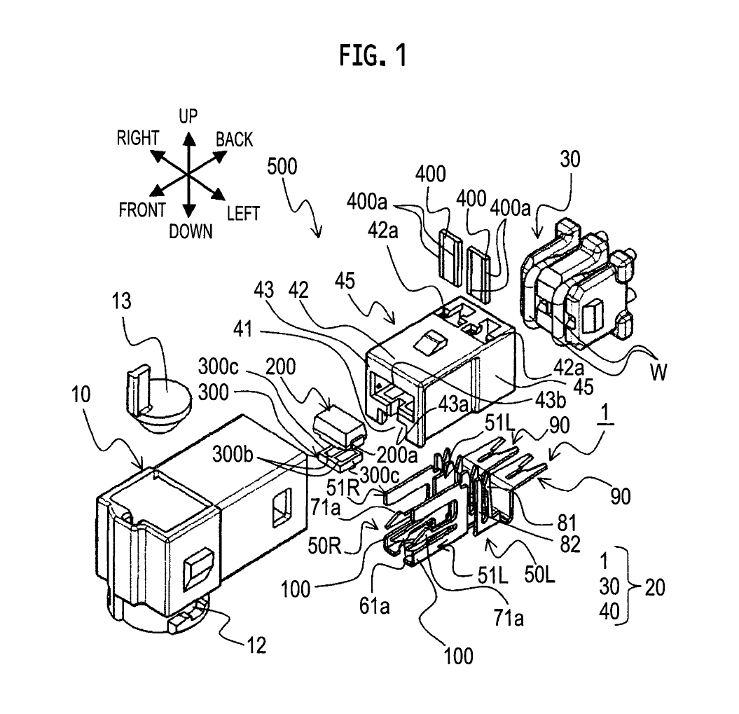

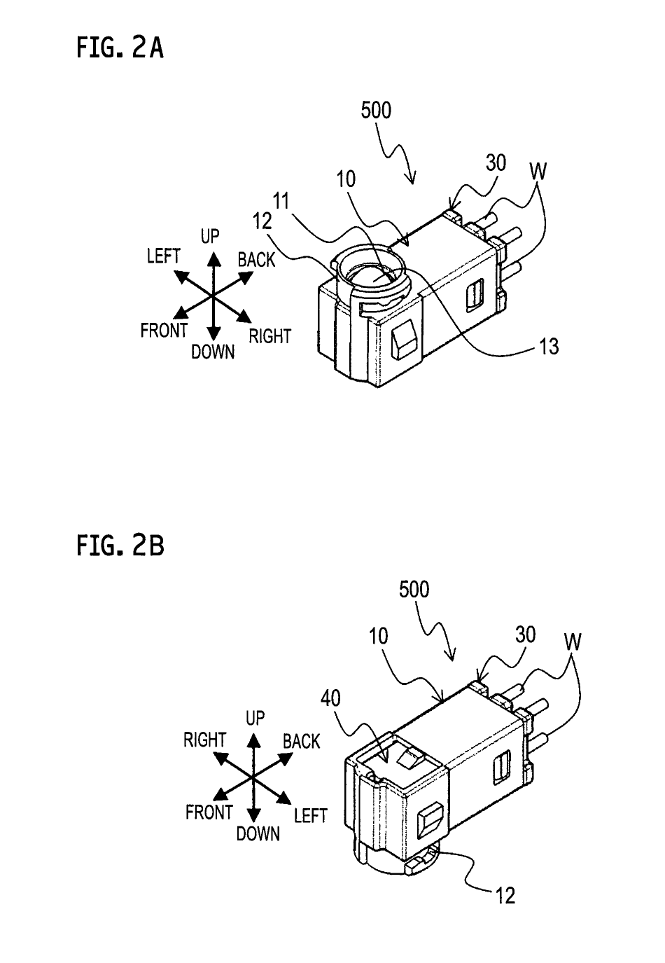

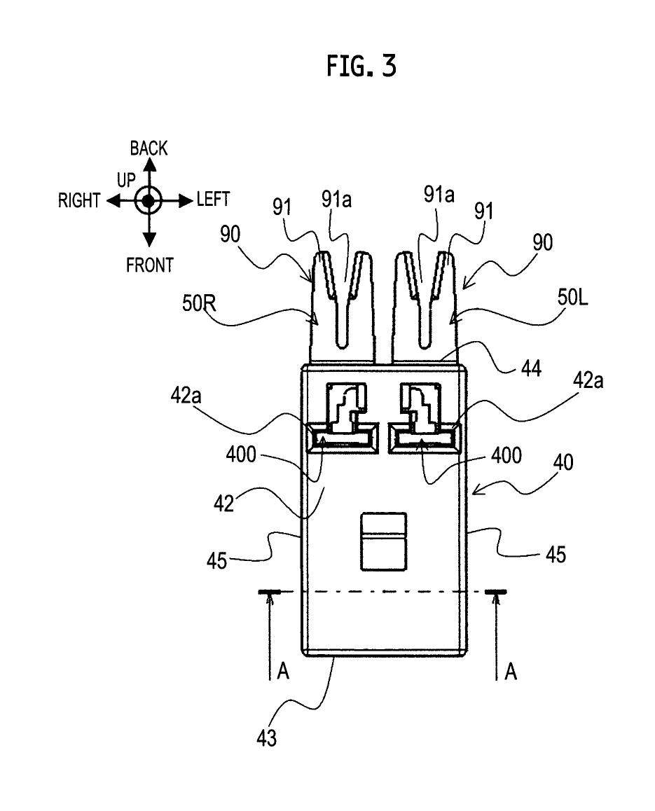

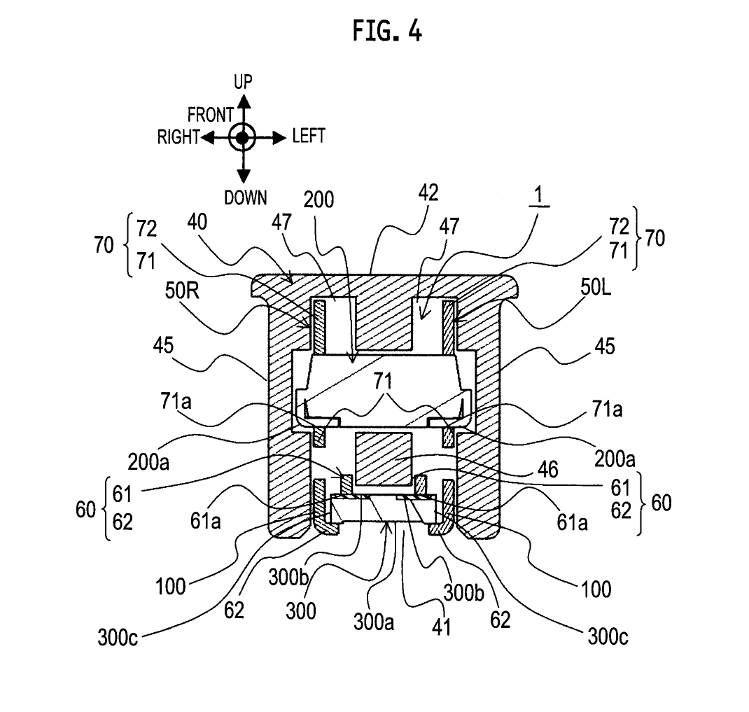

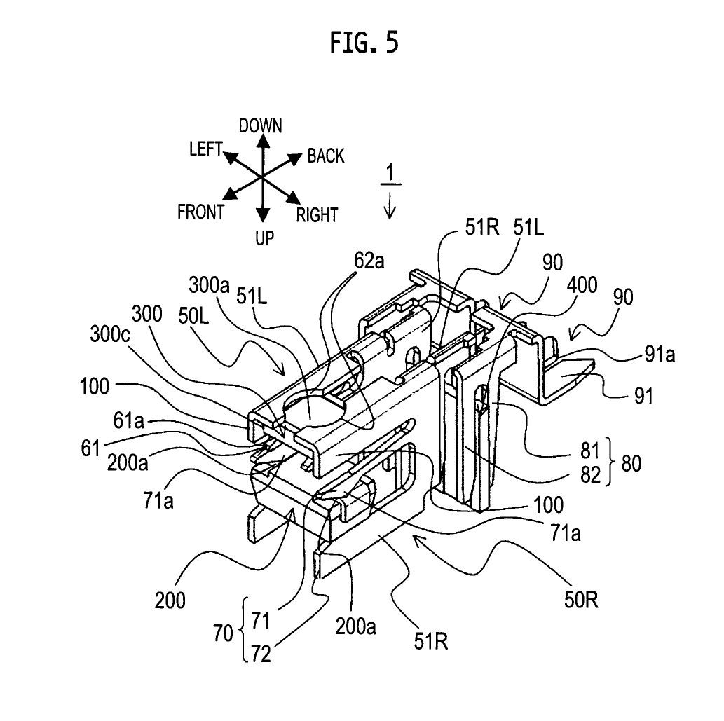

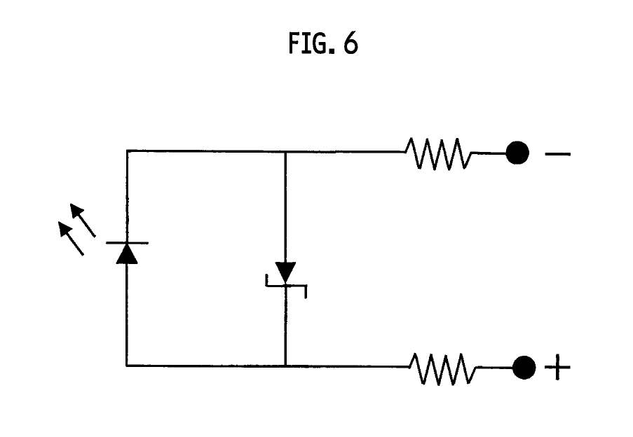

With reference to drawings, a connection structure for electric components according to an embodiment of the present invention will be described below. FIG. 1 is an exploded perspective view illustrating a lighting device 500 into which a connection structure 1 for electric components according to the embodiment is incorporated. FIG. 2A illustrates the lighting device 500 illustrated in FIG. 1 viewed from a side of a lens 13. FIG. 2B illustrates the lighting device 500 illustrated in FIG. 1 viewed from a back face side illustrated in FIG. 2A. FIG. 3 illustrates the connection structure 1 for the electric components stored in a housing 40 illustrated in FIG. 1 viewed from a back face side of the lens 13. FIG. 4 is a cross-sectional view taken along the line A-A illustrating the connection structure 1 for the electric components stored in the housing 40 illustrated in FIG. 3. FIG. 5 is a perspective view of the connection structure 1 for the electric components illustrated in FIG. 1. FIG. 6 is a circuit diagram illustrating a structure for a power supply circuit of LED 300 structured by a lighting function portion 20 illustrated in FIG. 1. For the sake of convenience, front and back, horizontal, and vertical directions are defined as illustrated in the diagrams. The connection structure 1 for the electric components according to the present embodiment will be incorporated into the lighting device 500 provided inside a room such as a vehicle. As illustrated in FIG. 1, the lighting device 500 includes a cover 10 and the lighting function portion 20.

First, the cover 10 will be described. The cover 10 is formed in a box-like shape using insulating material. The cover 10 includes an opening portion through which the lighting function portion 20 can be inserted at a back edge of the cover 10. Inside the cover 10, the lighting function portion 20 is stored. The cover 10 includes a window portion 11 through which light emitted from the LED 300 passes at a position corresponding to the LED 300 as a light source. The lens 13 for collecting the light emitted from the LED 300 is mounted at the window portion 11. The cover 10 according to the present embodiment includes a component mounting portion 12 cylindrically protruding from the window portion 11. A connection component (not illustrated) such as a light guiding member is mounted at the component mounting portion 12.

Subsequently, the lighting function portion 20 will be described. The lighting function portion 20 supplies power from an outside to the LED 300 to cause the LED 300 to emit the light. The lighting function portion 20 includes the connection structure 1 for the electric components, a wire holding portion 30 holding a wire “W” to be connected to an external power source (not illustrated), and the housing 40 storing the connection structure 1 for the electric components.

The connection structure 1 for the electric components includes a pair of bus bars 50R, 50L formed by shaping a conductive plate-shaped member. The bus bars 50R, 50L are disposed side by side in the horizontal direction. Between the bus bars 50R, 50L, a zener diode 200 as a first electric component, and the LED 300 as a second electric component are disposed side by side in a vertical direction, and they are electrically connected to the bus bars 50R, 50L. The LED 300 has a smaller width in the horizontal direction, and a smaller space between two electrodes of an electrode 300b in the horizontal direction than those of the zener diode 200. Further, according to the present embodiment, two resistances 400 are electrically connected to the pair of bus bars 50R, 50L.

The zener diode 200 is a known zener diode, and respective electrodes 200a as a positive electrode and a negative electrode are provided on one face of the zener diode 200. The LED 300 is a known LED, and has a cuboid-like shape as a whole. A light emitting portion 300a that emits light is provided on one face of the LED 300, and the respective electrodes 300b as the positive electrode and the negative electrode are provided on the other face thereof. The resistance 400 has a plate-like shape as a whole, and two electrodes 400a are provided on one face of the resistance 400.

The bus bars 50R, 50L are acquired by a press work such as bending or punching of a conductive plate-shaped member. The bus bars 50R, 50L include a right side wall 51R or a left side wall 51L that is an outside wall formed as an outside face when the bus bars 50R, 50L are disposed side by side in the horizontal direction. Each of the right side wall 51R and the left side wall 51L includes a contact 71a connecting to the one electrode 200a of the zener diode 200, and displacement-prevention wall portion 100 facing one of side faces 300c of the LED 300 in its vicinity to prevent the LED 300 from displacing with the paired bus bars 50R, 50L.

The bus bars 50R, 50L will be described. The bus bars 50R, 50L have a shape of mirror symmetry with respect to an intermediate face when the bus bars 50R, 50L are aligned. Therefore, the bus bar 50R (hereinafter, referred to as a “right-side bus bar”) disposed at a right side will be described in detail, and the bus bar 50L (hereinafter, referred to as a “left-side bus bar”) disposed at a left side will not be described.

The right-side bus bar 50R includes connection portions 60 connected to the two electrodes 300b, 300b of the LED 300, respectively and holding the LED 300, zener diode connection portions 70 connected to the two electrodes 200a, 200a of the zener diode 200, respectively and holding the zener diode 200, connection portions 80 holding a resistance 400 to connect to the electrodes 400a, 400a of the resistance 400, respectively, connection portions 90 connecting to the wire “W” held by the wire holding portion 30, and the displacement-prevention wall portion 100. The connection portions 60 and the zener diode connection portions 70 are provided such that an insertion opening of the LED 300 and an insertion opening of the zener diode 200 are disposed side by side vertically at a front edge end of the right-side bus bar 50R. The connection portions 80 and the connection portions 90 are sequentially connected at a back portion of the connection portions 60 and the zener diode connection portions 70.

The right-side bus bar 50R is formed by bending in a U-like shape a section from the connection portions 60 and the zener diode connection portions 70 to the connection portions 80 in a front and back direction. A portion of a section where the right-side bus bar 50R is bent is formed at the right-side wall 51R and the left-side wall 51L facing each other in the horizontal direction. As to the right-side wall 51R and the left-side wall 51L, when the right-side bus bar 50R is disposed side by side with the left-side bus bar 50L, the right-side wall 51R of the right-side bus bar 50R is positioned at the outer side of the right-side bus bar 50R and the left-side bus bar 50L to structure the outside wall. The left-side wall 51L is positioned at the inner side to structure the inside wall. Further, the punching work is performed on the right-side wall 51R and the left-side wall 51L to shape the connection portions 60, the zener diode connection portions 70, and the connection portions 80.

The connection portion 60 elastically urges the one electrode 300b of the LED 300, and includes a contact piece 61 connecting to the electrode LED 300b, and a wall portion 62 abutting on a lower face of the LED 300 urged downward by the contact piece 61.

As illustrated in FIG. 1, the contact piece 61 is formed by punching out a part of the left-side wall 51L into a piece. The contact piece 61 has elasticity, and its leading end portion is formed in a triangular shape including a top downward as a contact 61a in contact with the electrode 300b of the LED 300.

The wall portion 62 is protruded in a right angle from the right-side wall 51R to the bus bar 50L. Around a bending portion in a U-like shape between the right-side wall 51R and the left-side wall 51L, the punching work for forming the contact piece 61 is performed. The wall portion 62 is formed by bending in a right angle an end portion cut away from the contact piece 61 by the work described above from the right-side wall 51R to the bus bar 50L. Further, a cut-off portion 62a in an arc-like shape is formed not to interfere with light emitted from the light-emitting portion 300a of the LED 300.

The connection portions 60 hold the LED 300 while connecting to the electrode 300b of the LED 300 with the contact piece 61 and the wall portion 62, respectively.

The zener diode connection portion 70 elastically urges the one electrode 200a of the zener diode 200, and includes a contact piece 71 connecting to the electrode 200a and a piece portion 72 abutting on an upper face of the zener diode 200 urged upward by the contact piece 71.

The contact piece 71 is formed by punching out a part of the right-side wall 51R into a piece. The contact piece 71 has elasticity, and its leading end portion is formed in a triangular shape including a top upward as a contact 71a in contact with the electrode 200a of the zener diode 200.

The piece portion 72 is a part of the right-side wall 51R cut away from the contact piece 71 by the punching work for forming the contact piece 71.

The zener diode connection portions 70 hold the zener diode 200 while connecting to the electrode 200a of the zener diode 200 with the contact piece 71 and the piece portion 72, respectively.

The connection portion 80 includes an insertion opening of the resistance 400 at its upper end edge. The connection portion 80 elastically urges each electrode 400a of the resistance 400, and includes contact pieces 81, 81 connecting to the electrodes 400a of the resistance 400, and piece portions 82, 82 abutting on the resistance 400 urged backward by the pair of contact pieces 81, 81, respectively. The pair of contact pieces 81 are formed by punching out each one part of the right-side wall 51R and the left-side wall 51L into a piece.

The connection portions 80 hold the resistance 400 while connecting to both electrodes 400a, 400a of the resistance 400 with the contact pieces 81, 81 and the piece portions 82, 82, respectively.

A connection portion 90 is connected to the wire “W” held by the wire holding portion 30. The connection portion 90 structures a back end portion of the right-side bus bar 50R. The connection portion 90 includes a pressure blade 91 exposing outside from an opening portion 41 of the housing 40 and protruding backward. The pressure blade 91 is sequentially connected to the connection portion 80. A pressing-insertion groove 91a is formed on the pressure blade 91. The wire “W” held by the wire holding portion 30 is pressed and inserted into the pressure blade 91 with its insulating coat removed.

Subsequently, the displacement-prevention wall portion 100 will be described. The displacement-prevention wall portions 100 face the side faces 300c of the LED 300 respectively in its vicinity to prevent the LED 300 from displacing. A part cut away from the contact piece 71 is formed by partially punching out the right-side wall 51R to form the contact piece 71. The displacement-prevention wall portion 100 is formed by bending the part described above upward in a right angle with respect to the wall portion 62. Therefore, the displacement-prevention wall portion 100 is sequentially connected to the wall portion 62.

When the right-side bus bar 50R is disposed side by side with the left-side bus bar 50L, the displacement-prevention wall portion 100 is formed as the right-side wall 51R positioned at an outer side of the right-side bus bar 50R.

Further, for the left-side bus bar 50L, the displacement-prevention wall portion 100 is formed as the left-side wall 51L forming the outside face of the left-side bus bar 50L. Therefore, the displacement-prevention walls 100 for the bus bars 50R, 50L are disposed in the vicinity of the right and left side faces 300c, 300c of the LED 300. As a result, the LED 300 is prevented from displacing in the horizontal direction.

When the right-side bus bar 50R and the left-side bus bar 50L are disposed side by side in the horizontal direction, the connection portions 60 of the bus bars 50R, 50L are disposed inside, and the connection portions 70 are disposed outside as the outside walls forming the outside face. In other words, for the right-side bus bar 50R, the contact 61a is formed at the left-side wall 51L disposed inside and connected to the one electrode 300b of the LED 300. Further, the contact 71a is formed at the right-side wall 51R as the outside wall forming the outside face, and connected to the one electrode 200a of the zener diode 200.

On the other hand, for the left-side bus bar 50L, the contact 61a is formed at the right-side wall 51R disposed inside and connected to the other electrode 300b of the LED 300. Further, the contact 71a is formed at the left-side wall 51L as the outside wall forming the outside face, and connected to the other electrode 200a of the zener diode 200.

Therefore, in the connection structure 1 for the electric components, the outside walls of the pair of the bus bars 50R, 50L are disposed to correspond to the space between the electrodes 200a of the zener diode 200, and electrically connected to both electrodes 200a of the zener diode 200, respectively. As described above, the space between the outside walls of the bus bars 50R, 50L in the horizontal direction can be set to the minimum requisite value corresponding to the minimum requisite space between the electrodes 200a of the zener diode 200. In other words, a width of the connection structure 1 for the electric components in the horizontal direction is reduced to the requisite minimum value.

The displacement-prevention wall portion 100 is formed at the outside wall forming the outside face in a similar manner to the contact 71a. Therefore, a width of the connection structure 1 for the electric components in the horizontal direction can be prevented from increasing. For the outside wall of each of the bus bars 50R, 50L, the each displacement-prevention wall portion 100 is disposed in such a manner to become closer to the side face 300c of the LED 300 as much as possible within a range where the contact 71a can be connected to the electrode 200a of the zener diode 200. Therefore, the space between the side face 300c of the LED 300 and the displacement-prevention wall portion 100 can be reduced as much as possible.

Subsequently, the wire holding portion 30 will be described. As illustrated in FIG. 1, the wire holding portion 30 is stored in the cover 10 with two bent wires “W” held. The wire holding portion 30 causes each wire “W” to electrically connect to each of the bus bars 50R, 50L in the cover 10.

Subsequently, the housing 40 will be described. The housing 40 is a casing formed of insulating material into a block-like shape. A lower face of the housing 40 includes the opening portion 41 through which the pair of bus bars 50R, 50L are inserted. As illustrated in FIGS. 3 and 4, the housing 40 includes a bottom wall 42 in a rectangular shape, and a front wall 43, a back wall 44 facing the front wall 43, and a pair of side walls 45, 45 facing each other, elevated from four sides of the bottom wall 42. The housing 40 includes a partition wall 46 partitioning space formed of the walls 42, 43, 44, 45. The walls 42, 43, 44, 45, 46 structure a bus bar storage 47 for storing the bus bars 50R, 50L in the housing 40.

The front wall 43 includes insertion openings 43a, 43b formed side by side vertically. The LED 300 is inserted into the insertion opening 43a. The zener diode 200 is inserted into the insertion opening 43b. Further, the bottom wall 42 includes two insertion openings 42a. A resistance 400 is inserted into each insertion opening 42a.

The wires “W” are connected to the bus bars 50R, 50L respectively so that a lighting device 500 is connected to the external power source (not illustrated) . The power source supply circuit of the LED 300 illustrated in FIG. 6 is structured by electrically connecting the LED 300, the zener diode 200, two resistances 400, and the pair of bus bars 50R, 50L with one another.

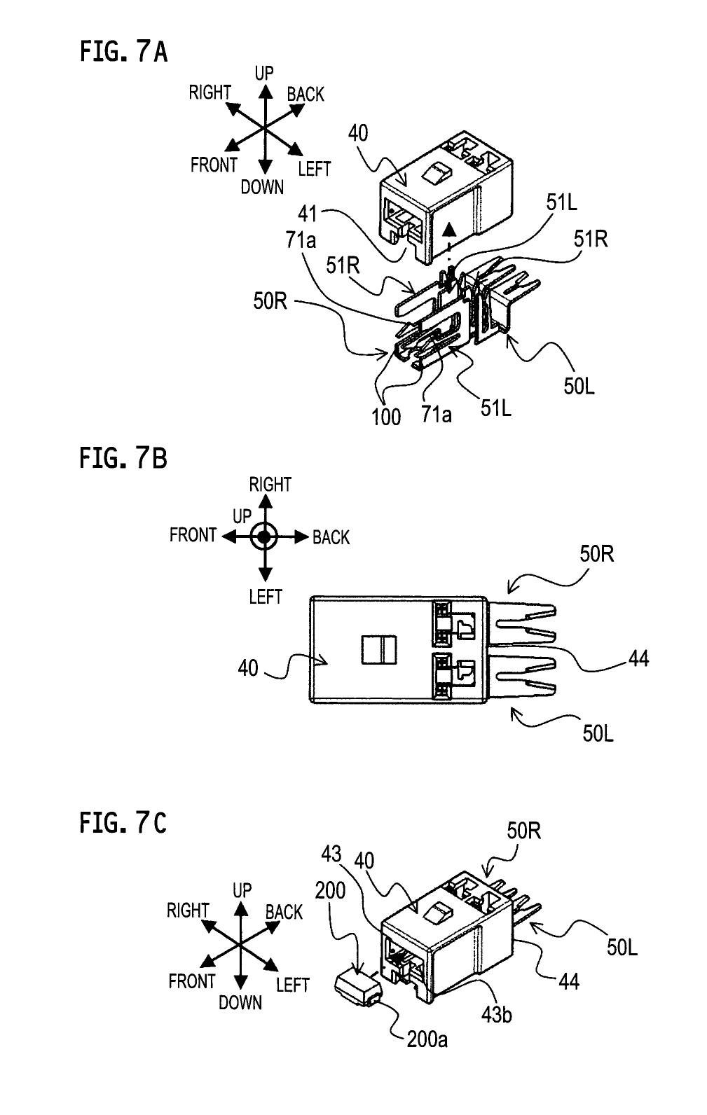

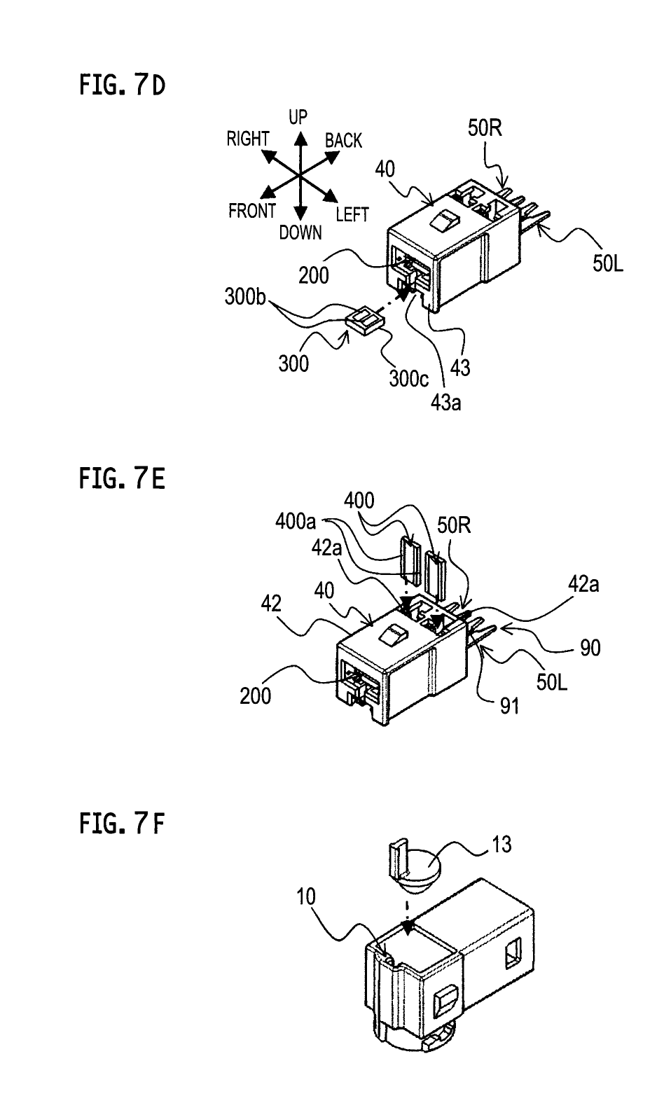

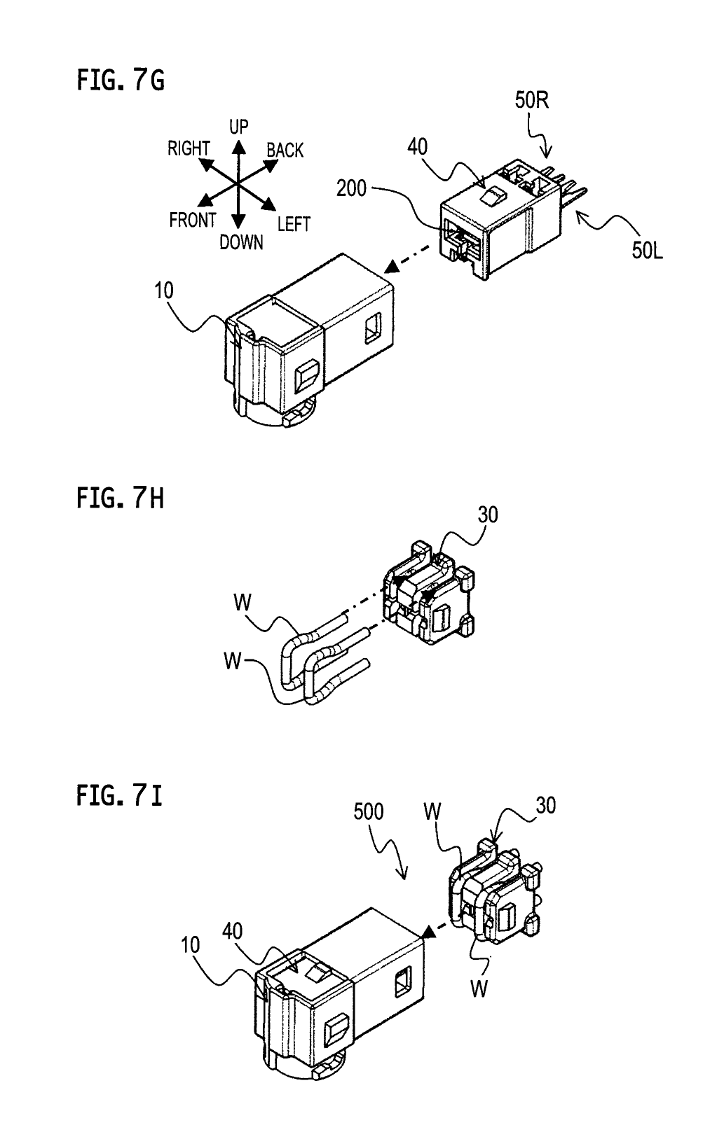

Herein, with reference to FIGS. 7A to 7I, assembly procedure of the lighting device 500 into which the connection structure 1 for the electric components is incorporated will be described. FIGS. 7A to 71 illustrate the assembly procedure of the lighting device 500 into which the connection structure 1 for the electric components is incorporated. First, an operator stores the bus bars 50R, 50L in bus bar storages 47 of the housing 40, respectively (refer to FIG. 7A). With this process, the bus bars 50R, 50L are disposed side by side in the horizontal direction. Further, a width of the pair of bus bar 50R, 50L in the horizontal direction in the state described above is suppressed to the space between the electrodes 200a of the zener diode 200.

Subsequently, the operator cuts a part of the bus bars 50R, 50L (refer to FIG. 7B). By the process described above, each resistance 400 is connected in series with respect to the zener diode 200 and the LED 300 as illustrated in FIG. 6.

Subsequently, the operator inserts the zener diode 200 into the housing via the insertion opening 43b to mount the zener diode 200 (refer to FIG. 7C). With this process, the zener diode 200 is held by a pair of contact pieces 71, 71 and a pair of piece portions 72, 72 so that the electrodes 200a are connected to the contacts 71a, respectively.

Subsequently, the operator inserts the LED 300 into the housing 40 via the insertion opening 43a to mount the LED 300 (refer to FIG. 7D). With this process, the LED 300 is held by a pair of contact pieces 61, 61 and a pair of wall portions 62, 62 so that the electrodes 400a are connected to the contacts 61a, respectively. Further, displacement of the LED 300 in the horizontal direction can be prevented by the displacement-prevention wall portions 100.

Subsequently, the operator mounts each resistance 400 by inserting each resistance 400 in the housing 40 via each insertion opening 42a (refer to FIG. 7E), mounts the lens 13 to the window portion 11 (refer to FIG. 7F), mounts the housing 40 in a state where each portion of the lighting function portion 20 is incorporated to the cover 10 (refer to FIG. 7G), mounts the wire “W” to the wire holding portion 30 (refer to FIG. 7H), and finally mounts the wire holding portion 30 to the cover 10 to connect the wires “W” with the bus bars 50R, 50L respectively, thereby completing the assembly of the lighting device 500 (refer to FIG. 7I).

When the bus bars 50R, 50L are disposed side by side in the connection structure 1 for the electric components according to the present embodiment, the contact 71a for the electrode 200a of the zener diode 200 is formed at the right-side wall 51R or the left-side wall 51L as the outside wall forming the outside face of each of the bus bars 50R, 50L. Since the space between the electrodes 200a is large, the space between the electrodes 200a, 200a of the zener diode 200 is larger than the width of the LED 300 in the horizontal direction mounted to the bus bars 50R, 50L and the space between the electrodes 300a, 300a in the horizontal direction. Therefore, a width of the pair of the bus bars 50R, 50L in the horizontal direction can be suppressed to the space between the electrodes 200a of the zener diode 200 that is the requisite minimum width. Further, the displacement-prevention wall portions 100 are formed at the right-side wall 51R or the left-side wall 51L as the outside walls of the pair of bus bars 50R, 50L. The displacement-prevention wall portions 100 face the side faces 300c of the LED 300 respectively in its vicinity to prevent the LED 300 from displacing. A width of the LED 300 is narrower than that of the zener diode 200. In other words, the displacement-prevention wall portions 100, 100 can prevent the LED 300 from displacing in the horizontal direction with a smaller arrangement than a width of the zener diode 200. Therefore, according to the present embodiment, the connection structure for the electric components can be made compact and further the displacement of the electric components can be prevented.

Further, since the space between the displacement-prevention wall portion 100 of each of the bus bars 50R, 50L and each side face 300c of the LED 300 can be suppressed to be small, the displacement of the LED 300 can be suppressed to be small.

Further, the right-side wall 51R or the left-side wall 51L of the bus bars 50R, 50L is formed as the outside wall of the pair of entire bus bars. The contacts 61a, 71a connected to the LED 300 and the zener diode 200 respectively, and the displacement-prevention wall portions 100, 100 are formed on the right-side wall 51R and the left-side wall 51L, respectively. The right-side wall 51R and the left-side wall 51L of the bus bars 50R, 50L are formed by bending the conductive plate-shaped member. Therefore, the bus bars 50R, 50L can be easily structured with the above described portions included.

As described above, according to the present embodiment, the connection structure for the electric components can be made compact and the electric components mounted to the connection structure 1 can be prevented from displacing.

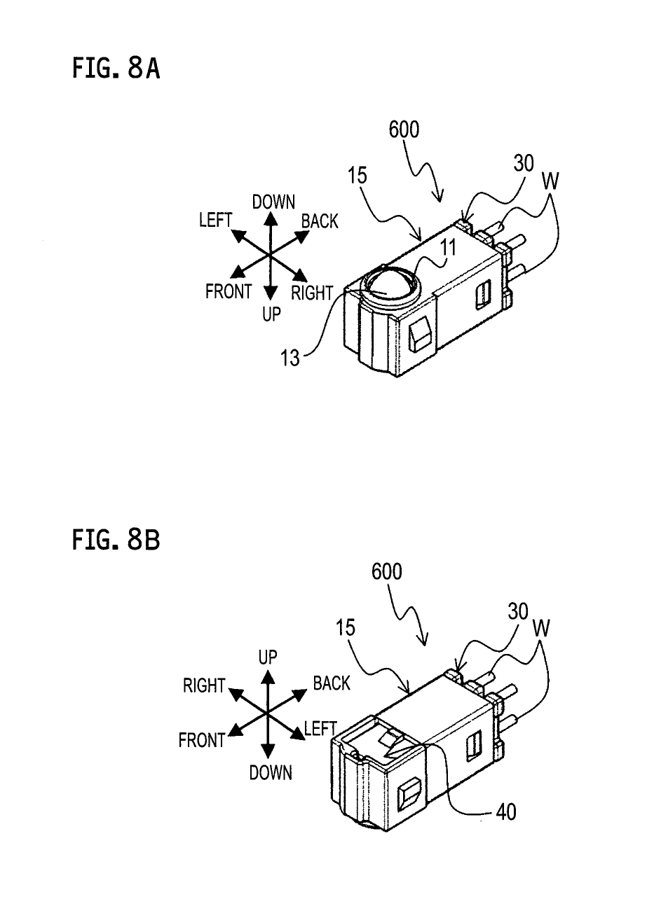

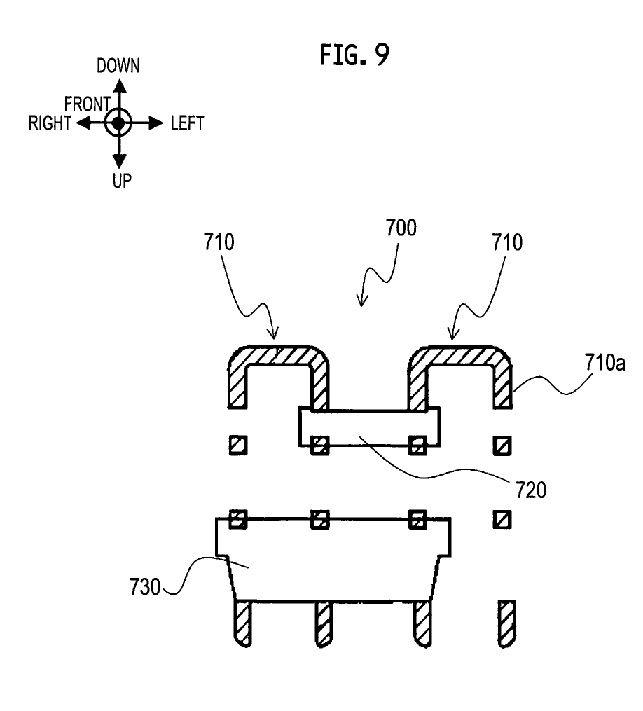

The lighting device 500 may be modified as described below. FIGS. 8A, 8B are perspective views of a lighting device 600 as a modification example of the lighting device 500. FIG. 8A illustrates the lighting device 600 viewed from the side of the lens 13. FIG. 8B illustrates the lighting device 600 viewed from the back face side illustrated in FIG. 8A. The lighting device 600 is different from the lighting device 500 in that the cover 15 does not include the component mounting portion 12. Other structure is the same as that described in the embodiment. Same reference symbols are applied to same structural elements as those in the embodiment. The connection structure 1 for the electric components incorporated into the lighting device 600, which is a modification example, is the same as the embodiment. Thus, the same effect as that of the embodiment can be acquired.

According to the present embodiment, the zener diode 200 is described as the first electric component, and the LED 300 is described as the second electric component. However, any electric component is not limited to the zener diode or the LED. More specifically, if a relationship in which a width of the second electric component in the horizontal direction is smaller than that of the first electric component and a space between the electrodes of the second electric component is smaller than that of the first electric component is satisfied, other electric component may be used.

The present invention is not limited to the above described embodiment, but various modifications can be applied within the scope that does not depart from the gist.

What is claimed is:

1. A connection structure for electric components, comprising:
a pair of conductive bus bars disposed side by side horizontally and configured to electrically connect to a first electric component and a second electric component in a state where the first electric component and the second electric component are disposed side by side vertically, the second electric component having a smaller width in a horizontal direction and a smaller space of two electrodes thereof in the horizontal direction than those of the first electric component,
wherein each of the bus bars includes
an outside wall formed as an outside face when the pair of bus bars are disposed side by side,
a contact formed at the outside wall to be connected to an electrode of the first electric component, and
a displacement-prevention wall portion formed at the outside wall to prevent the second electric component from displacing in the horizontal direction by facing a side face of the second electric component with the paired one of the bus bars.

2. The connection structure for electric components according to claim 1, wherein the outside wall of each of the bus bars is formed in such a manner that the electric component displacement-prevention wall portion becomes closer to the side face of the second electric component as much as possible within a range where the contact can be connected to the electrode of the first electric component.

3. The connection structure for electric components according to claim 1, wherein
the each bus bar includes a right-side wall and a left-side wall facing each other in a horizontal direction;
the outside wall is one of the right-side wall and the left-side wall and positioned at an outer side when the pair of bus bars are disposed side by side;
the other wall of the right-side wall and the left-side wall is an inside wall positioned at an inner side when the pair of bus bars are disposed side by side; and
the inside wall includes a contact connected to an electrode of the second electric component.

4. The connection structure for electric components according to claim 2, wherein
the each bus bar includes a right-side wall and a left-side wall facing each other in a horizontal direction;
the outside wall is one of the right-side wall and the left-side wall and positioned at an outer side when the pair of bus bars are disposed side by side;
the other wall of the right-side wall and the left-side wall is an inside wall positioned at an inner side when the pair of bus bars are disposed side by side; and
the inside wall includes a contact connected to an electrode of the second electric component.

5. The connection structure for electric components according to claim 1, wherein
the first electric component is zener diode, and
the second electric component is LED.
